(19) United States
(12) Patent Application Publication
(10) Pub. No.: US 2015/0309587 A1
(43) Pub. Date: Oct. 29, 2015

(54) PROTECTIVE COVER FOR PORTABLE ELECTRICAL DEVICE

(71) Applicant: HON HAI PRECISION INDUSTRY CO., LTD., New Taipei (TW)

(72) Inventors: CHIH-HUANG LIEN, New Taipei (TW); CHEN-JUNG FANG, New Taipei (TW); HUI-TING SHEN, New Taipei (TW); CHIEN-YU TSENG, New Taipei (TW); CHIN-CHOU LIN, New Taipei (TW)

(21) Appl. No.: 14/510,963

(22) Filed: Oct. 9, 2014

(30) Foreign Application Priority Data
Apr. 28, 2014 (TW) 103115159

(51) Int. Cl. G06F 3/023; F21V 33/00; G06F 1/16

(52) U.S. Cl. CPC G06F 3/023; G06F 1/1632; G06F 1/1662; G06F 1/1626; F21V 33/0048; F21W 2131/30

(57) ABSTRACT

A protective cover allowing unrestricted functionality to an electronic device includes a foldable protective board and a receiving portion containing the electronic device. The protective cover also includes a solar panel, a keyboard with touch input function and a wireless module. The wireless module is configured for wirelessly connecting the keyboard with the electronic device. A method for operating the protective cover is also provided.

### FIELD

The subject matter herein generally relates to the field of protective covers.

### BACKGROUND

Portable electronic devices provide great functionality and have capabilities in daily lives and can be a source of entertainment. Typically these devices are intended to be carried or moved about. As such, these devices are more vulnerable to damage. Protective cases are used to protect these devices from possible damage but the protective case may sometimes reduce the full functionality.

### BRIEF DESCRIPTION OF THE DRAWINGS

Implementations of the present technology will now be described, by way of example only, with reference to the attached figures.

FIG. 1 is an isometric view of an embodiment of a protective cover over a portable electronic device.

FIG. 2 is an isometric view of the protective cover as shown in FIG. 1 from another angle.

FIG. 3 is an isometric view of the protective cover as shown in FIG. 1.

FIG. 4 is an isometric view of a wireless module of the protective cover as shown in FIG. 1.

FIG. 5 is a flow diagram of a process for operation method of the protective cover.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

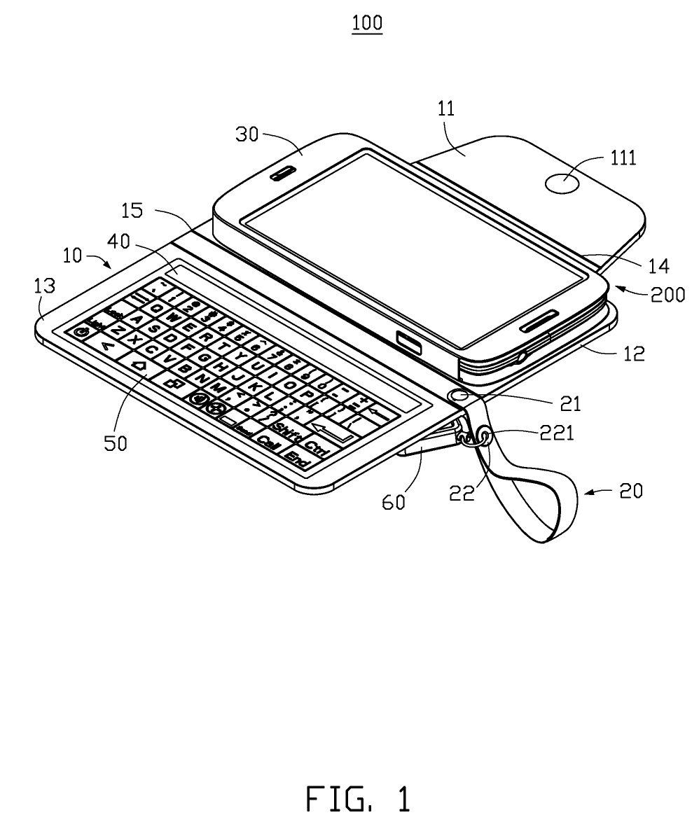

FIG. 1 illustrates a protective cover 100 according to an embodiment which can include a foldable protective board 10, a hand strap 20, a receiving portion 30, a solar panel 40, a keyboard 50 with touch function, and a wireless module 60.

The protective board 10 can include a latch board 11, a first protective board 12 and a second protective board 13 coupled together. The hand strap 20 can be connected to an edge of the protective board 10 for carrying the protective cover 100 conveniently. The receiving portion 30 can be attached on the first protective board 12. In at least one embodiment, the receiving portion 30 can be integrally formed with the first protective board 12. The solar panel 40 can be located on the second protective board 13. The keyboard 50 can be partly embedded in the second protective board 13.

The protective board 10 can be made of leather material. A connection between the latch board 11 and the first protective board 12 can include a crease 14. The latch board 11 can include a first buckle 111, and the first buckle 111 can be magnetic. In another embodiment, the first buckle 111 can be a snap-on button. A shape of the first protective board 12 can be substantially same as that of the second protective board 13. A connection between the first protective board 12 and the second protective board 13 can include a crease 15. A micro control unit (MCU) (not shown) and a wireless control chip (not shown) can be embedded in the protective board 10.

The hand strap 20 can be riveted for example to the protective board 10, by a rivet 21. In another embodiment, the hand strap 20 can be mounted to the protective board 10 by gluing, or other means of attachment, or integrally formed. The hand strap 20 can include a fastener 22 with a hole 221 defined therein.

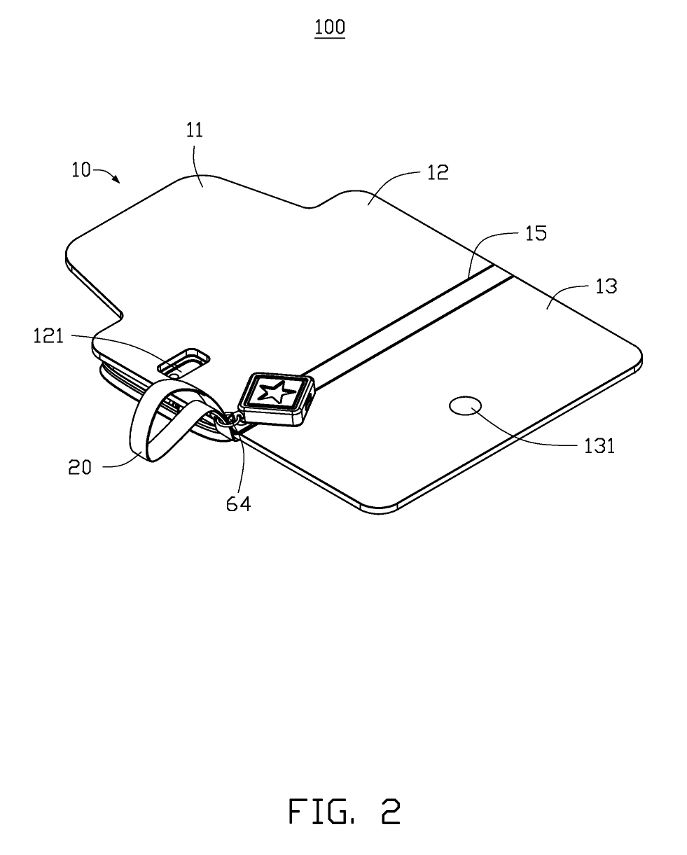

FIG. 2 illustrates that the protective board 10 can define a camera window 121 to correspond with a camera of the electronic device 200 (as shown in FIG. 1). The second protective board 13 can include a second buckle 131 to correspond with the first buckle 111 (as shown in FIG. 1). The second buckle 131 can be magnetic. In another embodiment, the second buckle 131 can be a snap-on button. The second protective board 13 can be folded along the crease 15 towards the first protective board 12. Then, the latch board 11 can be folded along the crease 14 (as shown in FIG. 1) and towards the first protective board 12. Thus, the latch board 11 can be attached to the second protective board 13, and the first buckle 111 can be buckled to the second buckle 131 to lock the protective board 10.

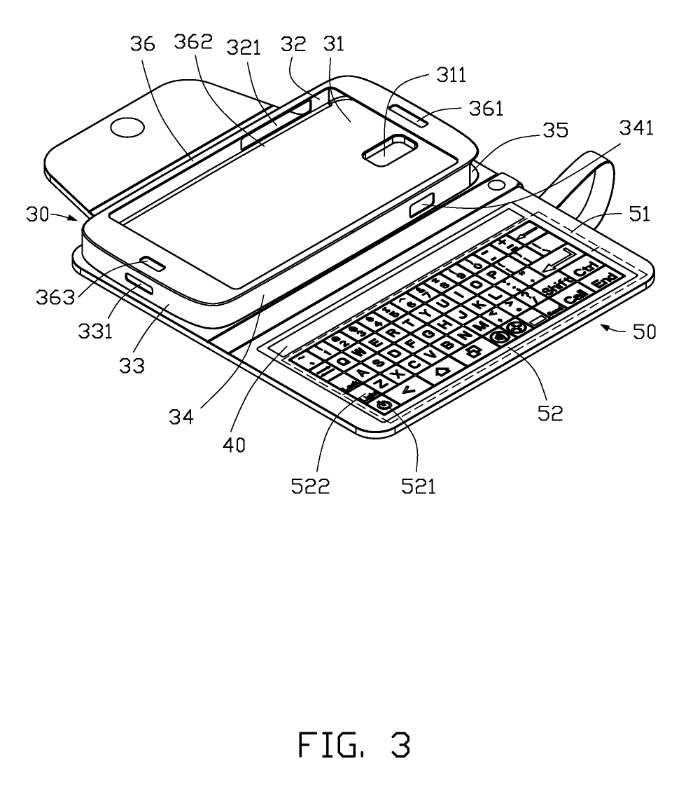

FIG. 3 illustrates that the receiving portion 30 can include a bottom board 31 attached onto the first protective board 12 (as shown in FIG. 1), a first sidewall 32, a second sidewall 33, a third sidewall 34, a fourth opening 35 facing the second sidewall 33, and a top board 36 facing the bottom board 31. The first sidewall 32, the second sidewall 33, and the third sidewall 34 can extend vertically along the bottom board 31. The electronic device 200 can be placed in the receiving portion 30 through the fourth opening 35. The bottom board 31 can define a first opening 311 at a place corresponding to the camera window 121 (as shown in FIG. 2). The first sidewall 32 can define a second opening 321 at a place to allow fingertip access to a volume button of the electronic device 200 (as shown in FIG. 1). The second opening 321 can allow a user to directly operate the volume button. The second sidewall 33 can define a third opening 331 to expose a universal serial bus (USB) port of the electronic device 200. The third sidewall 34 can define a fourth opening 341 to expose a power button of the electronic device 200. The top board 36 can define a fifth opening 361 to expose a handset of the electronic device 200, a sixth opening 362 to allow viewing of a display of the electronic device 200, and a seventh opening 363 to expose a loudspeaker of the electronic device 200. In another embodiment, openings of the receiving portion 30 can be as required and in such locations as necessary to accommodate a different electronic device 200.

The solar panel 40 (as shown in FIG. 1) can provide electrical energy for the keyboard 50 and the wireless module 60. In another embodiment, the solar panel 40 (as shown in FIG. 1) can be located on suitable positions such as a topmost surface out of the protective board 10.

The keyboard 50 can be a touch panel, and can have a function of accepting handwriting input. The keyboard 50 can include a first keypad 51 and a second keypad 52. The first keypad 51 can be same as computer keyboard, and can include numbers, letters, symbols, and other keys. The second keypad 52 can include a power key 521 and a backlight controlling key 522. The touch function of the keyboard 50 can be started or stopped when the power key 521 is activated. The backlight source of the keyboard 50 can be turned on or off when the backlight controlling key 522 being touched. In another embodiment, other function keys can be added.

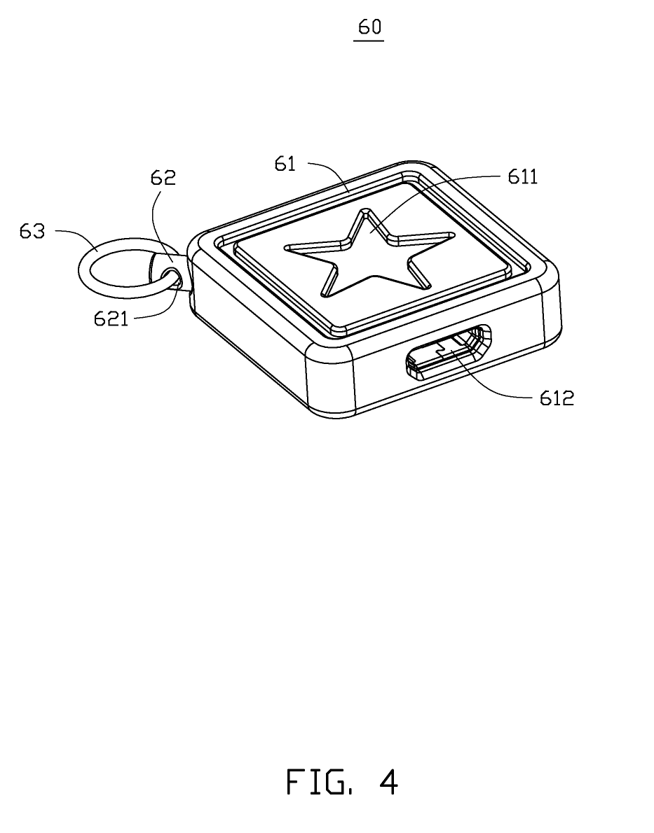

FIG. 4 illustrates the wireless module 60. In at least one embodiment, the wireless module 60 can be a BLUETOOTH module. The wireless module 60 can include a main body 61, a linking rod 62 rotationally connected to the main body 61, and a ring 63 connected to the linking rod 62. The main body 61 can be substantially cubic. In another embodiment, the main body 61 can be substantially triangular or spherical. A surface of the main body 61 can include a decoration to enhance the aesthetic of the wireless module 60 (for example, a symbolism 611). A side surface of the main body 61 can define a micro universal serial bus (micro USB) port 612. In another embodiment, the side surface of the main body 61 can define a USB port or other bus port. The linking rod 62 can be substantially a hollow column, and can define a hole 621 therein. The ring 63 can be connected to the linking rod 62 through the hole 621. The wireless module 60 can further include a wire 64 (as shown in FIG. 2). One end of the wire 64 can be connected to the micro USB port 612, and can pass out of the main body 61 through the linking rod 62. The other end of the wire 64 can be embedded in the protective board 10, and connected to the keyboard 50. A different software can be downloaded into the protective cover 100 by the micro USB port 612 and the wire 64 to give the keyboard 50 wireless input functionality for a different electronic device 200. The protective cover 100 can be connected to an external power supply by the micro USB port 612 to provide electrical energy for the keyboard 50 and the wireless module 60.

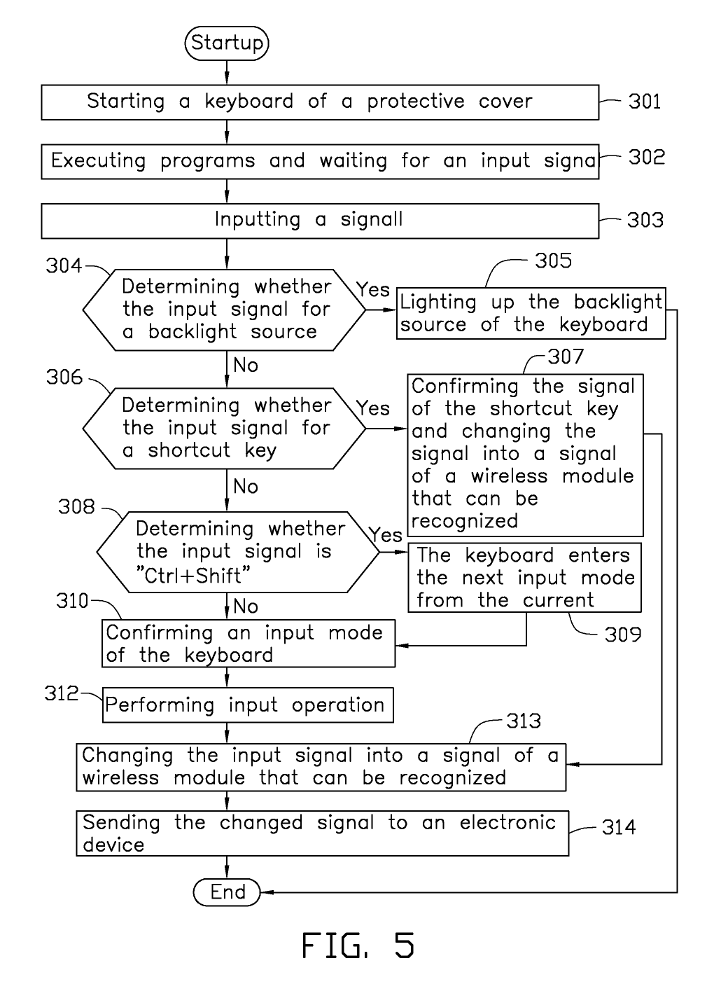

Referring to FIG. 5, a flowchart is presented in accordance with an example embodiment which is being thus illustrated. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 5 represents one or more processes, methods or subroutines, carried out in the example method. Additionally, the illustrated order of blocks is by example only and the order of the blocks can change according to the present disclosure. The example method can begin at block 301.

In block 301, a power key 521 can be activated, and a touch function of the keyboard 50 can be initialized.

In block 302, the keyboard 50 can recognize touches, and can wait for an input.

In block 303, a signal can be input. The signal can be a backlight controlling signal, a virtual shortcut signal, an input signal of handwriting, or other signal.

In block 304, the input signal can be determined to be a backlight controlling signal.

In block 305, if the input signal is determined as being the backlight controlling signal, the backlight source of the keyboard 50 can be turned on, and the program can be ended.

In block 306, a determination can be made that the input signal is a shortcut signal.

In block 307, if the input signal is determined to be the shortcut signal, an MCU can confirm contents of the shortcut signal, and contents of the shortcut signal can include to return to the previous page, to send text message, to return to a home page, to copy, to paste, or other. The control chip of wireless transmission can change the shortcut signal into a signal that can be recognized by a wireless module 60.

In block 308, a determination can be made that the signal is of input keys “Ctrl+Shift”.

In block 309, if a determination is made that the input signal is keys “Ctrl+Shift” being pressed, the keyboard 50 can cycle to the next input mode from the current input mode. The input mode can include Chinese input mode, other language input mode, and handwriting input mode. Then, the MCU can confirm the input mode of the keyboard 50.

In block 310, the MCU can confirm the input mode of the keyboard 50.

In block 312, the keyboard 50 can take touches and perform an input operation. The input contents can include numbers, Chinese language, English language, and handwriting and punctuation marks.

In block 313, the wireless control chip can change the input contents into signals that can be recognized by the wireless module 60.

In block 314, the wireless module 60 can communicate with the electronic device 200, and send the wireless signals to the electronic device 200 for the required commands to be executed.

The embodiments shown and described above are only examples. Many details are often found in the art such as the other features of the protective cover 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A protective cover for portable electrical devices comprising:
a foldable protective board;
a receiving portion attached on the foldable protective board and configured for receiving an electronic device;
a solar panel mounted on the foldable protective board;
a keyboard attached on the foldable protective board; and
a wireless module connected to the foldable protective board and wirelessly connecting the keyboard and the electronic device;

2. The protective cover for portable electrical devices as claimed in claim 1, wherein
the wireless module comprises a main body, a linking rod rotationally connected to the main body, and a ring connected to the linking rod;
the ring is connected to the foldable protective board simultaneously.

3. The protective cover for portable electrical devices as claimed in claim 2, wherein
the wireless module further comprises a wire;
the main body defines a universal bus port;
the linking rod defines a hole;
one end of the wire is connected to the universal bus port, and pass out of the main body through the linking rod;
the other end of the wire is embedded in the foldable protective board, and connected to the keyboard.

4. The protective cover for portable electrical devices as claimed in claim 1, wherein the keyboard is a touch panel, and have a function of accepting handwriting input.

5. The protective cover for portable electrical devices as claimed in claim 4, wherein
the keyboard comprises a power key and a backlight controlling key;
the power key is activated to start or stop the touch function of the keyboard;
the backlight controlling key is activated to turn on or off the backlight source of the keyboard.

6. The protective cover for portable electrical devices as claimed in claim 1, wherein the foldable protective board comprises a latch board, a first protective board and a second protective board coupled together.

7. The protective cover for portable electrical devices as claimed in claim 6, wherein
a connection between the latch board and the first protective board comprises a crease;
a connection between the first protective board and the second protective board comprises a crease.

8. The protective cover for portable electrical devices as claimed in claim 6, wherein the latch board comprises a first buckle, and the second protective board comprises a second buckle to correspond with the first buckle.

9. The protective cover for portable electrical devices as claimed in claim 1, wherein the protective cover further comprises a hand strap connected to an edge of the foldable protective board, and the wireless module is connected to the hand strap.

10. The protective cover for portable electrical devices as claimed in claim 9, wherein the hand strap comprises a fastener with a hole defined therein.

11. The protective cover for portable electrical devices as claimed in claim 1, wherein the receiving portion comprises a bottom board connected to the foldable protective board, a first sidewall, a second sidewall, a third sidewall, a fourth opening facing the second sidewall, and a top board facing the bottom board.

12. The protective cover for portable electrical devices as claimed in claim 11, wherein
the receiving portion defines a plurality of openings;
the first sidewall, the second sidewall, and the third sidewall extend vertically along the bottom board;
the electronic device can be placed in the receiving portion through the fourth opening.

13. An operation method of a protective cover for portable electrical devices, comprising:
initializing a touch function of a keyboard;
recognizing touches, and waiting for an input;
inputting a signal;
the input signal can be determined to be a backlight controlling signal;
a determination can be made that the input signal is a shortcut signal;
a determination can be made that the signal is of input keys “Ctrl+Shift”;
confirming an input mode of the keyboard;
performing an input operation;
changing input contents into signals that can be recognized by a wireless module;
sending the wireless signals to an electronic device.

14. The operation method as claimed in claim 13, wherein if the input signal is determined as the backlight controlling signal, the backlight source of the keyboard can be turned on, and the program can be ended.

15. The operation method as claimed in claim 13, wherein if the input signal is determined to be the shortcut signal, contents of the shortcut signal are confirmed, and then the shortcut signal is changed into a signal that can be recognized by the wireless module.

16. The operation method as claimed in claim 13, wherein a determination is made that the input signal is keys “Ctrl+Shift”, the keyboard cycles to the next input mode from the current input mode, and then the input mode of the keyboard is confirmed.
